(19) United States
(12) Patent Application Publication
(10) Pub. No.: US 2004/0139799 A1
(43) Pub. Date: Jul. 22, 2004

(54) Method and apparatus for determining flow rate of a fluid

(76) Inventors: David C. Sudolcan, Atascosa, TX (US); Thomas J. Chadwell, San Antonio, TX (US)

Correspondence Address: LAW OFFICES OF CHRISTOPHER L. MAKAY, 1634 Milam Building, 115 East Travis Street, San Antonio, TX, 78205, US

(21) Appl. No.: 10/625,841

(22) Filed: Jul. 23, 2003

Related U.S. Application Data
(60) Provisional application No. 60/398,456, filed on Jul. 25, 2002.

(51) Int. Cl. G01F 1/68

(52) U.S. Cl. 73/204.17

(57) ABSTRACT

A sensor for determining flow rate of a fluid includes a thermistor inserted into a volume through which the fluid flows. The thermistor cycles between its zero-power mode and its self-heated mode. In the zero-power mode, the thermistor is used to determine the ambient temperature of the fluid. In the self-heated mode, the thermistor is used to determine the amount of heat removed by the fluid. The ambient temperature of the fluid, the amount of heat removed by the fluid, and the thermal properties of the fluid are then utilized to determine the flow rate of the fluid.

### RELATED APPLICATION

This present application claims all available benefit, under 35 U.S.C. §119(e), of U.S. provisional patent application Serial No. 60/398,456 filed Jul. 25, 2002. By this reference, the full disclosure of U.S. provisional patent application Serial No. 60/398,456 is incorporated herein as though now set forth in its entirety.

### FIELD OF THE INVENTION

The present invention relates to fluid systems. More particularly, the invention relates to a method and apparatus for determining the flow rate of a fluid.

### BACKGROUND OF THE INVENTION

Temperature-based flow measurement typically employs first and second thermistors. The first thermistor operates in the zero-power mode and is used to determine the ambient temperature of the fluid. The second thermistor operates in the self-heated mode whereby a feedback circuit automatically adjusts the amount of power applied thereto such that the temperature of the second thermistor remains constant. A determination may then be made of the amount of power necessary to maintain the temperature of the second thermistor at a constant value. The ambient temperature of the fluid, the amount of power necessary to maintain the temperature of the second thermistor at a constant value, and the thermal properties of the fluid are then utilized to determine the flow rate of the fluid.

The first and second thermistors provide accurate determination of fluid flow rates; unfortunately, a two-thermistor configuration is often not economically viable because thermistors are relatively expensive. As such, applications involving large unit quantities cannot include temperature-based flow measurement employing thermistors due to cost considerations, and less desirable flow measurement schemes must be implemented. Accordingly, a temperature-based flow measurement scheme that receives the benefit of thermistor accuracy while reducing the costs associated with thermistor use would be desirable.

### SUMMARY OF THE INVENTION

In accordance with the present invention, a sensor for determining flow rate of a fluid generally comprises a sensor circuit and a thermistor. The thermistor is inserted into a volume through which the fluid flows, while the sensor circuit cycles the thermistor between its zero-power mode and its self-heated mode. The sensor for determining flow rate of a fluid further generally comprises a conversion circuit that measures the voltage drop across the thermistor and that converts the voltage drop across the thermistor in the zero-power mode and the voltage drop across the thermistor in the self-heated mode to the flow rate of the fluid through the volume.

The sensor circuit includes a configurable power controller that cycles the thermistor between its zero-power mode and its self-heated mode. The configurable power controller may include a variable resistance and a switch in association with the variable resistance. The switch cycles the variable resistance between a first value that operates the thermistor in its zero-power mode and a second value that operates the thermistor in its self-heated mode. Alternatively, the configurable power controller may include a configurable constant current or voltage source that cycles the thermistor between its zero-power mode and its self-heated mode.

In an alternative embodiment, the sensor circuit includes a reference circuit that stores a zero-power voltage reference value and a comparison circuit that compares the stored reference value with a changing zero-power voltage value associated with the dissipation of an injected known pulse of heat into a flowing fluid. The sensor circuit still further includes a timer circuit that measures the time required for the stored reference value to substantially equal the changing zero-power value associated with the dissipating injected pulse of heat. In the alternative embodiment, the conversion circuit converts the stored reference value, the time required to dissipate the known injected pulse of heat into the flowing fluid, and thermal properties of the fluid to the flow rate of the fluid through the volume.

In a method of measuring a flow rate of a fluid flowing through a volume, a thermistor is set to operate in a zero-power mode, and the ambient temperature of the fluid is determined. The thermistor is set to operate in a self-heated mode such that a known amount of energy may be supplied to the fluid. The amount of heat absorbed by the fluid is determined and then utilized with the ambient temperature of the fluid and thermal properties of the fluid to determine the flow rate of the fluid.

Alternatively, a thermistor is set to operate in a self-heated mode such that a known amount of energy may be supplied to the fluid. The amount of heat absorbed by the fluid is determined. The thermistor is set to operate in a zero-power mode, and the ambient temperature of the fluid is determined. The ambient temperature of the fluid, the amount of heat absorbed by the fluid, and thermal properties of the fluid are then utilized to determine the flow rate of the fluid.

In another method of measuring a flow rate of a fluid flowing through a volume, a thermistor is set to operate in a zero-power mode, and a resultant zero-power voltage is stored as a reference value. The thermistor is set to operate in a self-heated mode for a predetermined period of time such that a known pulse of heat is injected into the thermistor. The thermistor is set to operate in the zero-power mode, which allows the injected known pulse of heat to dissipate into the flowing fluid. The stored reference value is compared with a changing zero-power voltage value associated with the dissipating injected pulse of heat, and the time required for the stored reference value to substantially equal the changing zero-power value associated with the dissipating injected pulse of heat is measured. The stored reference value is used to determine the ambient temperature, and the flow rate of the fluid is determined utilizing the ambient temperature of the fluid, the time required to dissipate the known injected pulse of heat into the flowing fluid, and thermal properties of the fluid.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a schematic block diagram, a first embodiment of the fluid flow sensor of the present invention;

FIG. 2 shows, in a schematic diagram, the sensor circuit of the fluid flow sensor of FIG. 1;

FIG. 3A shows, in a schematic diagram, an equivalent circuit of a portion of the sensor circuit of FIG. 2 detailing a first mode of operation;

FIG. 3B shows, in a schematic diagram, an equivalent circuit of a portion of the sensor circuit of FIG. 2 detailing a second mode of operation;

FIG. 4A shows, in a graph, voltages over time across the thermistor of FIGS. 1 through 3 as typical when measuring a relatively low flow rate of a relatively cool fluid;

FIG. 4B shows, in a graph, voltages over time across the thermistor of FIGS. 1 through 3 as typical when measuring a relatively high flow rate of a relatively cool fluid;

FIG. 4C shows, in a graph, voltages over time across the thermistor of FIGS. 1 through 3 as typical when measuring a relatively low flow rate of a relatively hot fluid;

FIG. 4D shows, in a graph, voltages over time across the thermistor of FIGS. 1 through 3 as typical when measuring a relatively high flow rate of a relatively hot fluid;

FIG. 5 shows, in a table, various absolute and relative parameters of the circuit of FIG. 2 detailing operation of the circuit when measuring various flow rates of a room temperature fluid;

FIG. 6 shows, in a schematic block diagram, a second embodiment of the fluid flow sensor of the present invention;

FIG. 7 shows, in a schematic block diagram, a third embodiment of the fluid flow sensor of the present invention;

FIG. 8 shows, in a graphical representation, an operation cycle of the fluid flow sensor of FIG. 7; and

FIG. 9 shows, in a flowchart, one method for operation of the fluid flow sensor of FIG. 7.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

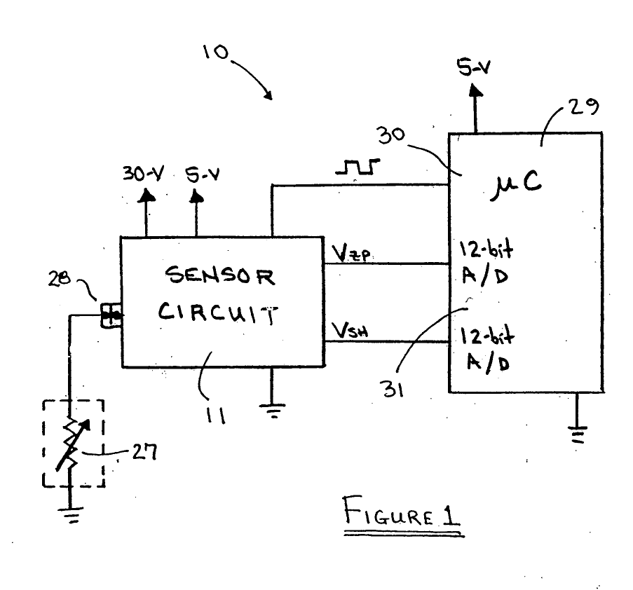

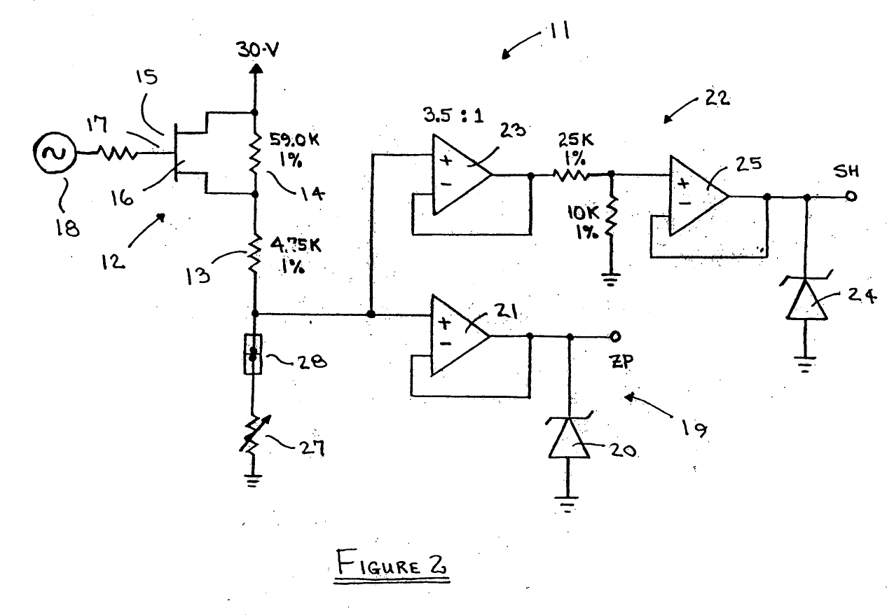

Referring now to FIGS. 1 and 2, a first embodiment of the fluid flow sensor 10 of the present invention, useful both for moderately robust direct closed-loop control of fluid flows and for obtaining calibrating measurements for open-loop flow control systems, is shown to generally comprise a sensor circuit 11 and a thermistor 27. The thermistor 27 is inserted into a volume through which a fluid flows. The sensor circuit 11, which preferably comprises a configurable power controller 12 and may also comprise one or more conversion circuits 19, 22, is then utilized to cycle the thermistor 27 between its zero-power mode and its self-heated mode. As will be better understood further herein, measurements of the voltage drop across the thermistor 27 taken during each of these modes may then be utilized to determine the flow rate of the fluid through the volume.

As particularly shown in FIG. 2, the configurable power controller 12 of the sensor circuit 11 may be readily implemented by providing a fixed resistance 13 in series with a switched resistance 14. A switch 15, which may simply comprise a power field effect transistor 16, may then be utilized to selectively bypass the switched resistance 14 according to the signal level from a signal generator 18 applied to the input 17 of the transistor 16. As will be apparent to those of ordinary skill in the art, when the transistor 16 is switched on, a short circuit bypassing the switched resistance 14 is created, resulting in high current flow through the fixed resistance 13 and, thus, the thermistor 27, which sets the thermistor in its self-heated mode of operation. Likewise, when the transistor 16 is switched off, the switched resistance 14 is placed in series with the fixed resistance 13, resulting in low current flow through the fixed resistance 13 and, thus, the thermistor 27, which sets the thermistor in its zero-power mode of operation. It should be understood by those of ordinary skill in the art that a configurable constant current or voltage source may be substituted for the configurable power controller 12.

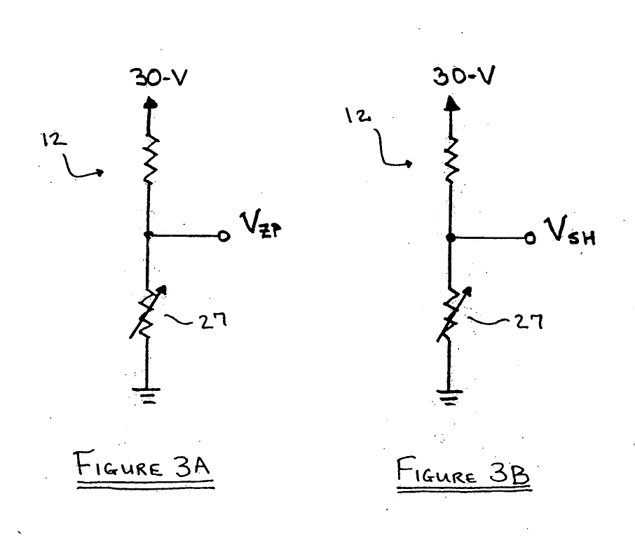

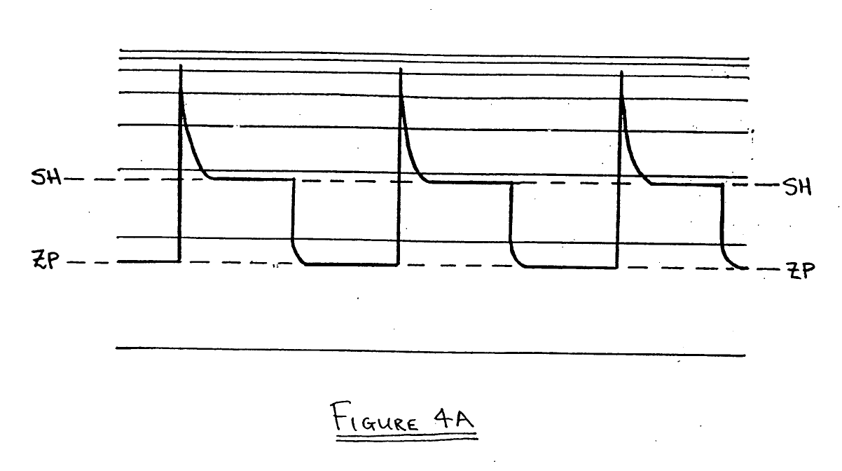

Referring now to FIGS. 3A and 3B, equivalent circuits showing the configurable power controller 12 in series with the thermistor 27 between the high side and the low side of the power source are shown for the low current and high current cases, respectively. Although the resistance values depicted are largely a matter of design choice, it is noted that the values should be chosen such that the low current case depicted in FIG. 3A results in operation of the thermistor 27 in its zero-power mode while the high current case depicted in FIG. 3B results in operation of the thermistor 27 in its self-heated mode. Additionally it is noted that the present invention may be implemented with the thermistor 27 on the high side of the power source. As will be better understood further herein, however, Applicant has found that implementation on the low side enables attainment of better resolution from the fluid flow sensor 10 at lower component cost.

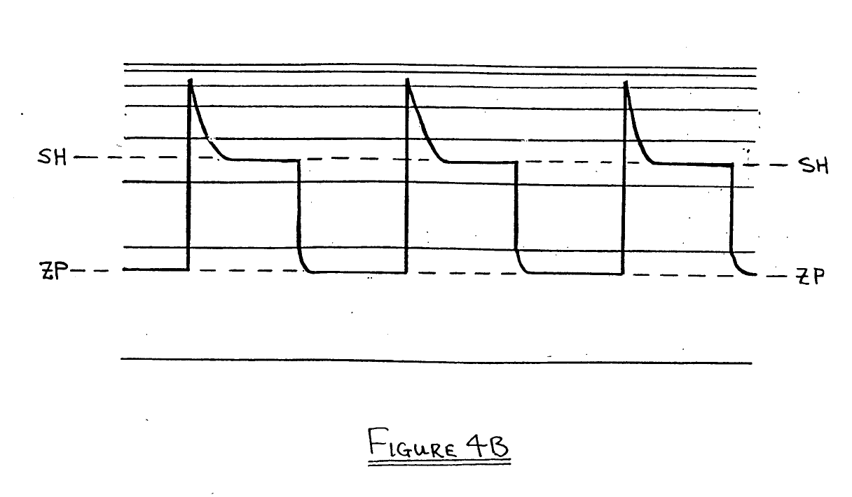

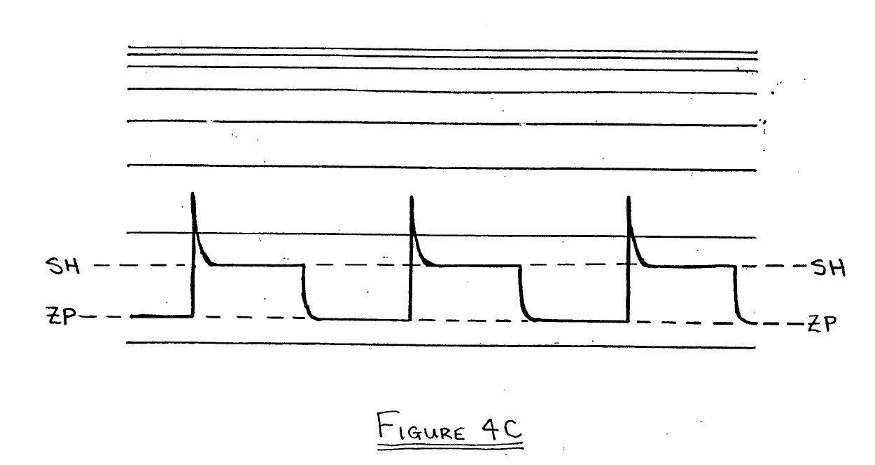

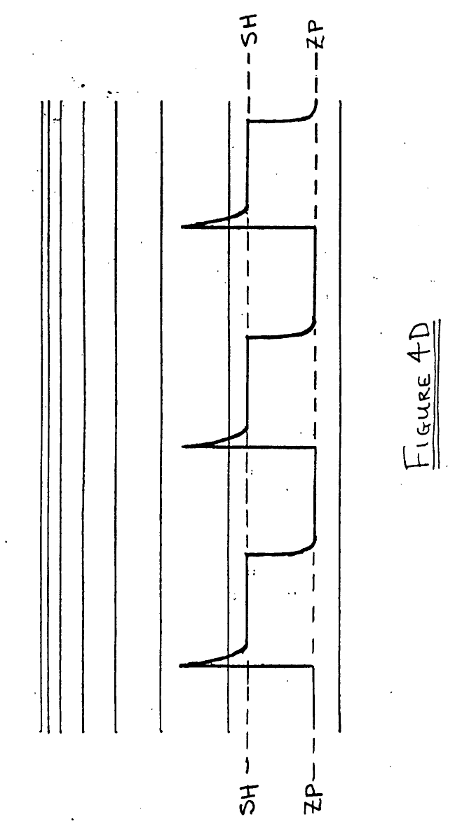

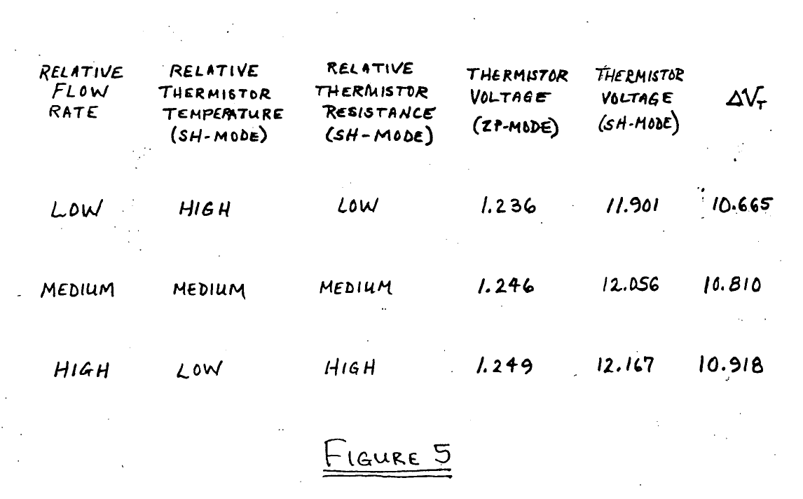

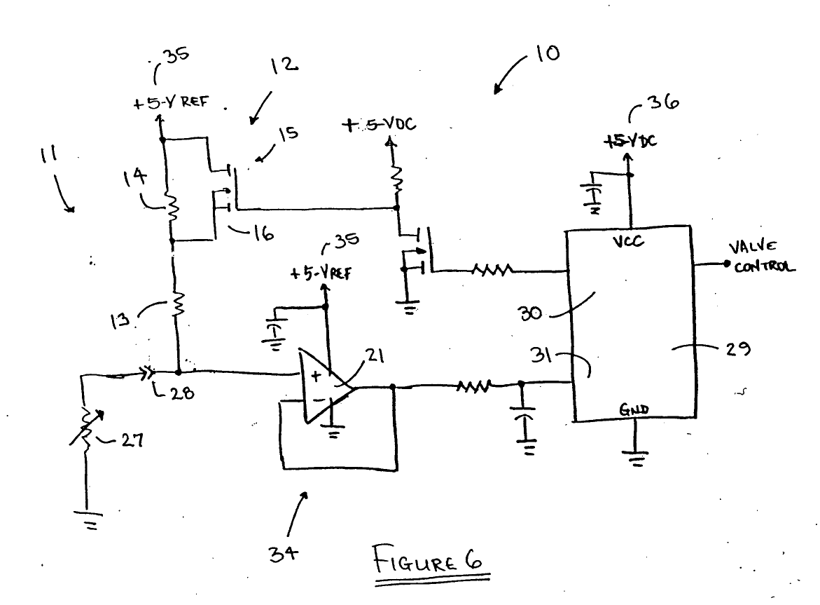

While, as previously mentioned, the particular resistance values selected for implementation of the present invention are largely a matter of design choice, the implementing engineer should carefully consider the range of voltages expected across the thermistor 27, which will be directly related to both: (1) the temperature or temperatures of fluids flowing through the volumetric space and (2) the range of possible flow rates of the fluids. Additionally, as shown in the waveform graphs of FIGS. 4A through 4D, the thermal response of the thermistor 27 is logarithmic. As such, careful consideration should be given to the selection of resistance values in order to ensure that adequate resolution may be obtained from the voltage measuring hardware. Further, as previously mentioned, Applicant has found it desirable to locate the thermistor 27 on the low side of the power source, thereby enabling the use of the conversion circuits 19, 22 depicted in FIG. 2.

In operation of the present invention, the thermistor 27 is cycled back and forth between its zero-power and self-heated modes. As the thermistor 27 is cycled with the thermistor 27 inserted into a fluid flow, voltage waveforms such as are depicted in FIGS. 4A through 4D are produced across the thermistor 27. As shown in the figures, the absolute value of the zero-power voltage will vary according to the temperature of the fluid flowing through the volume due to the thermal effect of the fluid upon the resistance of the thermistor 27. Additionally, it is noted that the zero-power voltage and the difference between the zero-power voltage and the self-heated voltage is in direct relation to the rate of flow of the fluid through the volume, due to the ability of a faster flowing fluid to remove more of the heat energy produced by the thermistor 27 in its self-heated mode. These voltages are measured and through calculation or resort to lookup tables, converted to an accurate indication of the flow rate of the fluid through the volume.

As shown in FIG. 1, a controller 29 is preferably provided for storing the obtained voltage measurements in memory and for converting the obtained voltage measurements to indications of flow rate. In particular, Ohm's law is used to convert the zero-power voltage of the thermistor 27 into a resistance value. The zero-power resistance value is then converted into the ambient temperature of the fluid flowing through the volume through use of conversion information provided by the manufacturer of the thermistor 27. Similarly, Ohm's law is used to convert the self-heated voltage of the thermistor 27 into a resistance value. The self-heated resistance value is then converted into the temperature of the thermistor operated in self-heated mode through the use of conversion information provided by the manufacturer of the thermistor 27. By injecting a known amount of energy (as heat) into the thermistor 27 when operated in its self-heated mode, the thermistor 27 should stabilize at a known temperature. However, since fluid flowing past the thermistor 27 removes a quantity of this energy through cooling of the thermistor 27, the thermistor 27 stabilizes at an actual lower temperature. Accordingly, the difference between the known temperature and the actual lower temperature yields the amount of energy (heat) removed by the flowing fluid from the thermistor 27. The flow rate of the fluid may thus be determined using one of several methods including, but not limited to, a formula or lookup table involving the previously calculated ambient temperature of the flowing fluid and the amount of heat removed by the flowing fluid as well as the thermal properties of the fluid flowing past the thermistor 27, which may be empirically determined as would be well understood by those of ordinary skill in the art.

While the foregoing description is exemplary of this embodiment of the present invention, those of ordinary skill in the relevant arts will recognize the many variations, alterations, modifications, substitutions and the like as are readily possible, especially in light of this description, the accompanying drawings and claims drawn thereto. For example, necessary components, such as analog-to-digital converters 31 and a signal generator 30 for operation of the switch 15 may be provided integral with the controller 15 or may be separately implemented. Likewise, zero gain isolation amplifiers 21, 25 and clamping protection Zener diodes 20, 24 are also preferably provided in the conversion circuits 19, 22 to prevent interference with the measured signals and to protect the controller 29 from the high voltage that would otherwise occur upon disconnection of the connector 28 connecting the thermistor 27 to the sensor circuit 11. In any case, because the scope of the present invention is much broader than any particular embodiment, the foregoing detailed description should not be construed as a limitation of the scope of the present invention, which is limited only by the claims appended hereto.

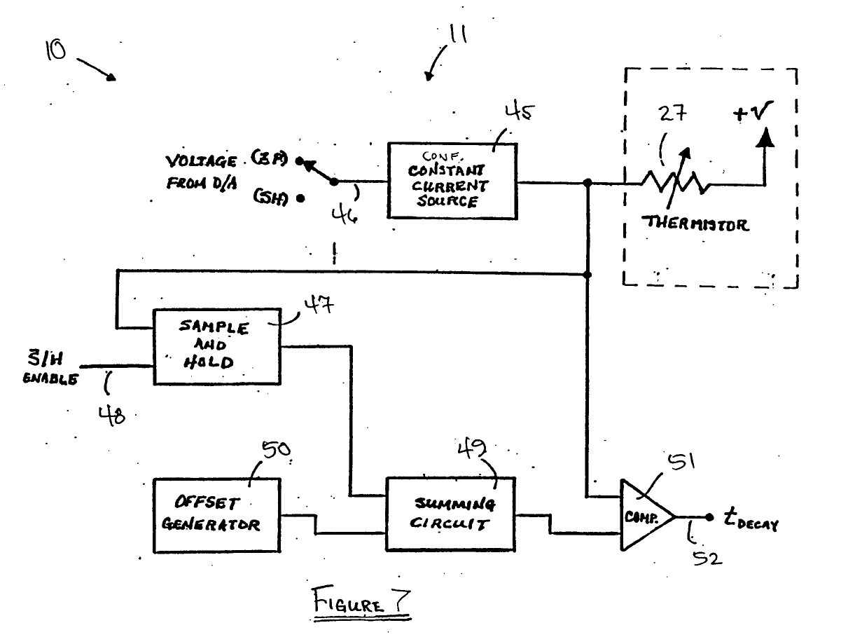

As shown in FIG. 6, a second embodiment of the present invention, also useful both for moderately robust direct closed-loop control of fluid flows and for obtaining calibrating measurements for open-loop flow control systems, comprises a single output circuit 34 from the sensor circuit 11, which is driven by a 5-V power supply 35 as opposed to the 30-V power supply shown for the first embodiment of the present invention. In this manner, component cost savings may be realized in circumstances under which the lower voltage power supply is sufficient for generating adequately high self-heated mode temperatures in the thermistor 27, thereby eliminating the need for the voltage divider circuit 23 implemented in the first embodiment. The implementing engineer is cautioned, however, that the necessity for the higher power supply voltage is dictated by the thermal properties of the fluid or fluids flowing through the volumetric space. As a result, resort to empirical methods may be required in determining the adequacy of the implementation of the second embodiment in favor of the first embodiment.

Of particular benefit in applications requiring very high accuracy in measurement and/or flow control, the implementation of FIG. 6 also depicts the utilization of a first isolated and regulated power source 35, for supply of power to the thermistor 27 and its isolation amplifier 21, and one or more separate power sources 36 for supply of power to all other electrical components. Additionally, the isolated and regulated power source 35 may also be monitored by whatever device (such as the microcontroller 29 depicted in FIG. 6) implemented for measuring the voltage drop across the thermistor 27. In any case, the power requirements of the latter components are prevented in this manner from distorting the measurements obtained from the sensor circuit 11, thereby resulting in more accurate measurement of fluid flows. While not shown in every depiction of the various embodiments of the present invention, it should be understood that the foregoing provisions may be implemented in conjunction with any or all of the various embodiments.

Finally, as previously noted, the second embodiment as depicted in FIG. 6 comprises a microcontroller 29. While the provision of a microcontroller 29 is in no way necessary to the present invention, the depiction of FIG. 6 serves to illustrate that in embodiments that do comprise a microcontroller 29 or the like, the microcontroller 29 (or substantial equivalent thereof) may be utilized to produce the toggling signal for switching the thermistor 27 between its zero-power and self-heated modes, to measure the voltage drop across the thermistor 27, to calculate based upon measured voltages the flow rate of the fluid passing through the volumetric space and/or to control a valve provided to effect flow rate through the volumetric space. While not shown in every depiction of the various embodiments of the present invention, it should be understood that such a controller 29 (or any other functionally equivalent device or circuit) may be implemented for the provision of any or all of the foregoing functions.

While each of the foregoing embodiments are capable for use for moderately robust real-time control of fluid flows through a volumetric space, their response times are limited by the time required for the voltage waveforms that occur as the single thermistors 27 are cycled between their zero-power mode and their self-heated mode to stabilize, as depicted in the waveforms of FIGS. 4A through 4D. In particular, the period at which the thermistors 27 may be cycled back and forth between their zero-power and self-heated modes can be no shorter than what is necessary to give time for the waveform to settle stably in the current mode of operation.

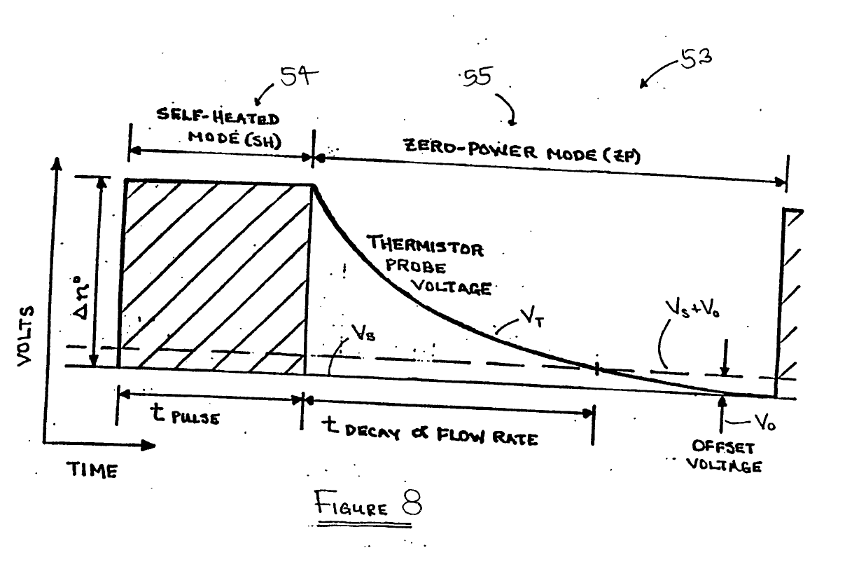

Referring now to FIG. 7, a third embodiment of the fluid flow sensor 10 of the present invention, useful both for direct closed-loop control of relatively stable fluid flows and for obtaining calibrating measurements for open-loop flow control systems, is shown to generally comprise a sensor circuit 11 and a thermistor 27. The thermistor 27 is projected into a fluid flow. In operation of the present invention, as will be better understood further herein, the sensor circuit 11 injects a constant amount of energy, in the form of heat, into the thermistor 27, which is thereafter dissipated into the fluid flow at a rate directly related to the rate of the fluid flow. As a result, Applicant has discovered that an accurate indication of the fluid flow rate may be obtained by measuring the time t_{D} required for the temperature of the thermistor 27 to return to a temperature near the ambient temperature of the fluid.

The sensor circuit 11 is adapted to selectively operate the thermistor 27 in either a self-heated mode or a zero-power mode depending upon the current delivered to the thermistor 27 from a configurable constant current source 45, which is configurable according to the voltage level at its input 46 generated by a D/A converter. Alternatively, the sensor circuit 11 may selectively operate the thermistor 27 in either a self-heated mode or a zero-power mode depending upon the voltage delivered to the thermistor 27 from a configurable constant voltage source, which is configurable according to the voltage level at its input generated by a D/A converter. It should be understood by those of ordinary skill in the art that the configurable power controller 12 of the first embodiment may be substituted for the configurable constant current or voltage source. In this manner, a controller (not shown) may be programmed to inject the constant amount of energy into the thermistor 27 and, thereafter, to measure the time t_{D} required to dissipate the injected energy. Although a simple resistive voltage divider or other circuitry may be implemented as a cost saving measure, it is noted that use of a configurable circuit such as herein described enables the circuit 11 to be adjusted for the delivery of different amounts of energy depending upon the thermal characteristics of the metered fluid should such an adjustment be found necessary.

A sample and hold circuit 47 is adapted to store the voltage V_{S} measured at the thermistor 27 just prior to injection to the thermistor 27 of the energy. A comparator 51 may then be implemented to compare the thermistor voltage V_{T} with a threshold voltage V_{S}+V_{O}, which is the sum of the sampled baseline voltage V_{S} and an offset voltage V_{O}. The offset voltage V_{O} is desirably provided in order that flow rate may be calculated notwithstanding that all of the injected energy may not in fact be dissipated from the thermistor 27 into the fluid. In any case, a summing circuit 49, having inputs taken from an offset generator 50 and the output from the sample and hold circuit 47, may be readily implemented to provide an output to the comparator 51 of the threshold voltage V_{S}+V_{O}.

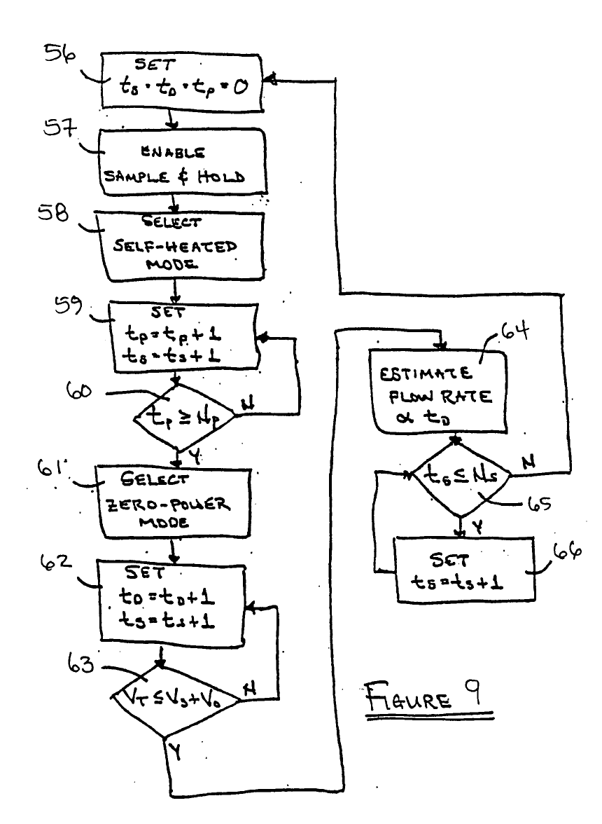

Referring now in particular to FIGS. 8 and 9, operation of the fluid flow sensor 10 of the third embodiment is shown to generally begin with the initialization (step56) within the controller of various local time variables, including time variable tₛ measuring the overall sample rate of the system, a time variable t_{D} measuring the decay of the voltage V_{T} on the thermistor 27 (indicative of the time required for the thermistor 27 to cool following injection thereto from the configurable constant source 45 of the energy pulse) and a time variable t_{P} measuring the amount of energy injected into the thermistor 27. The controller then generates an appropriate input to the sample enable 48 on the sample and hold circuit for the enabling (step 57) of the sample and hold circuit 47. In this manner, the baseline voltage V_{S}, which will drift with changes in ambient temperature, is obtained and stored for later use in determining the time T_{D} required for the temperature of the thermistor 27 to return to near ambient following injection of the energy pulse.

As particularly shown in FIG. 8, the sampling cycle waveform 53 generally comprises a self-heated mode stage 54 during which the temperature of the thermistor 27 will rapidly increase Δn° as energy is injected from the configurable constant current source 45 and a zero-power mode stage 55 during which the temperature of the thermistor 27 will cool as heat dissipates from the thermistor 27 into the flow through the valve. The next step in operation of the fluid flow sensor 10 is therefore the selection (step 58) of the self-heated mode for the thermistor 27.

During the self-heated mode stage 54, the controller repeatedly increments (step 59) the sample counter t_{S} and the pulse width counter t_{P} and checks (step 60) to determine whether the desired amount of energy has been injected into the thermistor 27 by comparing the pulse width counter t_{P} with a predetermined number N_{P} of counts required for injection of the desired amount of energy. If the pulse width counter t_{P} has not yet reached the predetermined number N_{P} of counts, the thermistor 27 is maintained in its self-heated mode and the sample counter t_{S} and pulse width counter t_{P} are again incremented (repeating step 59). On the other hand, once the pulse width counter t_{P} reaches the number N_{P} of required counts, the controller varies the voltage at the input 46 to the configurable constant current source 45 such that thermistor 27 is returned to the zero-power mode (step).

During the zero-power mode stage 55, the controller repeatedly increments (step 62) the sample counter ts and the decay counter t_{D} and checks (step 63) to determine whether the energy previously injected into the thermistor 27 has been substantially dissipated therefrom into the fluid flow. In particular, the comparator 51 is utilized to compare the thermistor voltage V_{T} with the threshold voltage V_{S}+V_{O}. For so long as the thermistor voltage V_{T} remains above the threshold voltage V_{S}+V_{O}, the sample counter t_{S} and the decay counter t_{D} continue to be incremented (repeating step 62). On the other hand, once the thermistor voltage V_{T} is determined by the comparator 51 to have fallen below the threshold voltage V_{S}+V_{O} the controller recognizes a change in the output 52 from the comparator 51 indicating that the controller may then make an estimation (step 64) of the flow rate through the valve as a value proportional to the last value of the time t_{D}, which represents the length of time required for the injected energy to dissipate from thermistor 27 into the fluid flow.

The system and method of the third embodiment contemplates variance of the sample baseline voltage V_{S} as the ambient temperature changes and/or energy remains stored in the form of heat within the thermistor 27. Applicant has recognized that it may be desirable to allow the passage of some minimum length of time prior to reinitiating the cycle waveform 53 in order that substantially all of the injected energy may be dissipated from the thermistor 27. In this manner, the thermistor 27 is prevented from accumulating a measurement error over time. In such an embodiment, the controller may be programmed to make a determination (step 65) of whether sufficient time has passed to allow the thermistor 27 to cool to a stable baseline temperature. In particular, the controller may be programmed to compare the sample counter t_{S} with a predetermined number N_{S} of counts to determine whether the desired time has passed. If not, the controller continues to increment (step 66) the sample counter t_{S}. If so, however, the cycle waveform 53 begins again with initialization of the time variables (repeating step 56).

While a particular timing scheme has been set forth in this exemplary only description in order to clearly convey the teachings of the third embodiment, Applicant's teachings should in no manner be limited to this particular scheme. Many other implementations are possible depending upon the circumstances in which the invention is put to use, including without limitation utilization of a controller with an interrupt on timeout feature, hardware controlled timing and others. All such implementations should be considered as falling within the scope of the present invention.

While the foregoing descriptions are exemplary of the embodiments of the present invention, many variations, alterations, modifications, substitutions and the like as are readily possible. For example, the teachings of the present invention may be utilized in any of a variety of applications, including for the direct control of a valve metering out a quantity of fluid, as a calibration or check for other controllers and as an input upon which may be based an adjustment to a valve such as may be required due to heating of the valve or wear in the valve's internal components. Regardless of the particular application, however, systems incorporating the foregoing principles as well as the method for calculation of flow should be considered within the scope of Applicant's invention. In any case, because the scope of the present invention is much broader than any particular embodiment, the foregoing detailed description should not be construed as a limitation of the scope of the present invention, which is limited only by the claims drawn hereto.

What is claimed is:

1. A sensor for determining flow rate of a fluid through a volume, comprising:
a thermistor at least partially inserted into the volume; and
a sensor circuit adapted to cycle the thermistor between a zero-power mode and a self-heated mode.

2. The sensor as recited in claim 1, wherein the sensor circuit comprises a configurable power controller adapted to cycle the thermistor between a zero-power mode and a self-heated mode.

3. The sensor as recited in claim 2, wherein the configurable power controller comprises:
a variable resistance; and
a switch in association with the variable resistance, the switch being adapted to cycle the variable resistance between a first value and a second value, the first value being selected to operate the thermistor in the zero-power mode and the second value being selected to operate the thermistor in the self-heated mode.

4. The sensor as recited in claim 3, wherein the thermistor is in series with the variable resistance between a first side of a power source and a second side of a power source.

5. The sensor as recited in claim 4, wherein the thermistor is arranged in series with the variable resistance at the high side of the power source.

6. The sensor as recited in claim 4, wherein the thermistor is arranged in series with the variable resistance at the low side of the power source.

7. The sensor as recited in claim 1, further comprising a conversion circuit for use in measuring the voltage drop across the thermistor.

8. The sensor as recited in claim 6, wherein the conversion circuit comprises a first channel for measuring the voltage drop across the thermistor when the thermistor is in its zero-power mode and a second channel for measuring the voltage drop across the thermistor when the thermistor is in its self-heated mode.

9. The sensor as recited in claim 7, wherein each the channel comprises an isolation amplifier.

10. The sensor as recited in claim 7, wherein the second channel comprises a voltage divider for scaling down the voltage drop across the thermistor.

11. The sensor as recited in claim 6, wherein the conversion circuit is adapted to convert the voltage drop across the thermistor from logarithmic scale.

12. The sensor as recited in claim 6, wherein the conversion circuit comprises a micro-controller adapted to convert the voltage drop across the thermistor in the zero-power mode and the voltage drop across the thermistor in the self-heated mode to the flow rate of the fluid through the volume.

13. The sensor as recited in claim 3, wherein:
the variable resistance comprises a first fixed resistor in series with a second fixed resistor; and
the switch comprises a transistor in parallel with the first fixed resistor such that the transistor is operable to bypass the first fixed resistor.

14. The sensor as recited in claim 2, wherein the configurable power controller comprises a configurable constant current source adapted to cycle the thermistor between a zero-power mode and a self-heated mode.

15. The sensor as recited in claim 1, wherein the sensor circuit further comprises a reference circuit adapted to store a zero-power voltage as a reference value.

16. The sensor as recited in claim 15, wherein in the self-heated mode a known pulse of heat is injected into the thermistor for a predetermined period of time.

17. The sensor as recited in claim 16, wherein the sensor circuit further comprises a comparison circuit that compares the stored reference value with a changing zero-power voltage value associated with the dissipation of the injected known pulse of heat into the flowing fluid.

18. The sensor as recited in claim 17, wherein the sensor circuit further comprises a timer circuit that measures the time required for the stored reference value to substantially equal the changing zero-power value associated with the dissipating injected pulse of heat.

19. The sensor as recited in claim 18, wherein the sensor circuit further comprises an offset circuit that adds an offset voltage value to the stored reference value thereby accommodating for variations in the ambient temperature of the flowing fluid.

20. The sensor as recited in claim 18, further comprising a conversion circuit adapted to convert the stored reference value, the time required to dissipate the known injected pulse of heat into the flowing fluid, and thermal properties of the fluid to the flow rate of the fluid through the volume.

21. The sensor as recited in claim 2, wherein the configurable power controller comprises a configurable constant voltage source adapted to cycle the thermistor between a zero-power mode and a self-heated mode.

22. A method of measuring a flow rate of a fluid flowing through a volume, comprising:
setting a thermistor to operate in a zero-power mode;
determining the ambient temperature of the fluid;
setting the thermistor to operate in a self-heated mode;
supplying a known amount of energy to the fluid;
determining the amount of heat absorbed by the fluid; and
determining the flow rate of the fluid utilizing the ambient temperature of the fluid, the amount of heat absorbed by the fluid, and thermal properties of the fluid.

23. The method as recited in claim 22, wherein determining the ambient temperature of the fluid, comprises:
measuring the zero-power voltage of thermistor;
converting the zero-power voltage to a resistance value; and
converting the resistance value to a temperature value.

24. The method as recited in claim 22, wherein determining the self-heated temperature of the thermistor, comprises:
measuring the self-heated voltage of thermistor;
converting the self-heated voltage to a resistance value; and
converting the resistance value to a temperature value.

25. A method of measuring a flow rate of a fluid flowing through a volume, comprising:
setting a thermistor to operate in a self-heated mode;
supplying a known amount of energy to the fluid;
determining the amount of heat absorbed by the fluid;
setting the thermistor to operate in a zero-power mode;
determining the ambient temperature of the fluid; and
determining the flow rate of the fluid utilizing the ambient temperature of the fluid, the amount of heat absorbed by the fluid, and thermal properties of the fluid.

26. The method as recited in claim 25, wherein determining the ambient temperature of the fluid, comprises:
measuring the zero-power voltage of thermistor;
converting the zero-power voltage to a resistance value; and
converting the resistance value to a temperature value.

27. The method as recited in claim 25, wherein determining the self-heated temperature of the thermistor, comprises:
measuring the self-heated voltage of thermistor;
converting the self-heated voltage to a resistance value; and
converting the resistance value to a temperature value.

28. A method of measuring a flow rate of a fluid flowing through a volume, comprising:
setting a thermistor to operate in a zero-power mode;
storing a resultant zero-power voltage as a reference value;
setting the thermistor to operate in a self-heated mode for a predetermined period of time thereby injecting a known pulse of heat into the thermistor;
setting the thermistor to operate in a zero-power mode thereby allowing the injected known pulse of heat to dissipate into the flowing fluid;
comparing the stored reference value with a changing zero-power voltage value associated with the dissipating injected pulse of heat;
measuring the time required for the stored reference value to substantially equal the
changing zero-power value associated with the dissipating injected pulse of heat;
determining the ambient temperature of the fluid utilizing the stored reference value; and
determining the flow rate of the fluid utilizing the ambient temperature of the fluid, the time required to dissipate the known injected pulse of heat into the flowing fluid, and thermal properties of the fluid.

29. The method as recited in claim 28, further comprising adding an offset voltage value to the stored reference value thereby accommodating for variations in the ambient temperature of the flowing fluid.

30. The method as recited in claim 28, wherein determining the ambient temperature of the fluid utilizing the stored reference value, comprises:
measuring the zero-power voltage of thermistor;
converting the zero-power voltage to a resistance value; and
converting the resistance value to a temperature value.
